(19) United States
(12) Patent Application Publication
(10) Pub. No.: US 2014/0165466 A1
(43) Pub. Date: Jun. 19, 2014

(54) Method of growing plants that conserves water

(71) Applicant: Julian Bob Cordova, Midland, TX (US)

(72) Inventor: Julian Bob Cordova, Midland, TX (US)

(21) Appl. No.: 13/714,374

(22) Filed: Dec. 13, 2012

(51) Int. Cl. A01G 1/00; A01G 9/02

(52) U.S. Cl. CPC A01G 1/001; A01G 9/02
USPC 47/66.7; 47/58.1 R

(57) ABSTRACT

A method of growing a plant is provided in which a plant is planted at a location in which a horizontal layer of rock dust is placed over a lower layer of plant growing medium and an upper layer of plant growing medium is placed over the layer of rock dust.

### BACKGROUND OF THE INVENTION

1. Field of the Invention

This invention relates generally to methods of conserving water, and in particular relates to a method of growing plants that allows water to be conserved.

2. Description of the Related Art

Various methods of reducing water use when growing plants are known. For example, it is known that plant growing materials such as vermiculites, perlites, wood fibers and the like may be added to soil of potted plants to adsorb and retain water (for example, see U.S. Pat. No. 3,373,355). It is also known that soil may be mixed with cross-linked anionic polyacrylamide, which sells when the soil is watered. (U.S. Pat. No. 4,540,427). Also, cement kiln dust may be combined with a water-soluble binder to produce agglomerates that are dried and used to condition soil (U.S. Pat. Nos. 5,743,934 and 5,997,599).

When rocks are pulverized to create gravel suitable for roads, smaller rock particles, including rock powders and dust are also formed, and are typically treated as waste products. Rock powders and various rock minerals have been mixed into soils or broadcast over soils or added by fertigation (in irrigation waters) to improve their fertility, particularly to improve soil cation exchange capacity, soil structure and drainage, as well as to provide calcium, iron, magnesium, phosphorus, potassium and trace elements and micronutrients.

As a by-product of rock crushing, rock dust, passing through a 200 screen, and therefore having particle diameters of less than 0.003 inch (74 microns), is formed as a waste product and is typically buried to remove it from the rock crushing facility. The rock dust is separated from the larger rock particles (e.g., granite, limestone, trap rock, sand and gravel) by an air separator. Air separators, for example the Fisher Air Separator (Fisher Industries, Dickinson, N. Dak.) and the Phoenix Sand and Gravel Separation Systems (Phoenix Process Equipment Co., Louisville, Ky.) remove unwanted fines from aggregate applications such as rock-crushing operations and quarry sites, with the rock dust being discharged on to conveyors for disposal.

Prior methods of conserving water in the planting and growing of plants typically require mixing of components with soil that is then used in a pot or a hole in which a plant is planted, and are often difficult to use efficiently for plantings that are larger than individual potted plants.

It is therefore an object of the invention to provide a method of growing plants in which a layer of rock dust is used to retain and conserve water.

Other objects and advantages will be more fully apparent from the following disclosure and appended claims.

### SUMMARY OF THE INVENTION

The invention herein is a method of growing plants in which the plants are grown in soil containing a rock dust layer sandwiched between a lower growing, medium and a top layer of growing medium such as soil. Other objects and features of the inventions will be more fully apparent from the following disclosure and appended claims.

### BRIEF DESCRIPTION OF THE DRAWINGS

FIG. 1 is a schematic cross-sectional view of a plant planted in a pot prepared according to the invention herein.

FIG. 2 is a schematic cross-sectional view of a plant planted individually outdoors according to the invention herein.

FIG. 3 is a schematic cross-sectional view of a sod planting according to the invention herein.

### DETAILED DESCRIPTION OF THE INVENTION AND PREFERRED EMBODIMENTS THEREOF

The present invention provides a method of growing a plant to conserve water.

In the method of the invention herein, a rock dust layer sandwiched between a in plant growing medium and a top layer of plant growing medium is used to conserve water. The plant growing medium is typically soil or potting soil, but may be any other medium conducive to plant growth as known in the art.

Rock dust is obtained from air separators or other methods of obtaining the rock dust from quarries and other mining operations after rock has been mined and ground up for other uses as known in the art. The rock source of the rock dust may be any known in the art, so long as rock dust, the finer the better can be obtained from the rock source and the rock source does not contain components that are deleterious to plant growth or have other unwanted characteristics as known in the art. Preferably the rock dust. used in the invention is small enough to pass through a 200 screen as known in the art. Thus, the rock to dust particles used in the invention herein most preferably have a diameter no greater than 74 microns (200 screen).

With particles this small, a layer of rock dust as used in the invention herein is able to slow down the movement of water through the soil. The rock dust as used in the invention is not being used to provide nutrients or any particular elements to the plants, but rather is being used, in a layer, because of its fine particulate nature to provide a moisture-holding result. Therefore, use of totally inert rock dust that has no particular nutrient value to the plants is within the invention herein. Although rock dust is the most preferred fine material to be used in the invention herein, it is also contemplated the other fine material from other sources may be used in the “rock dust” layer as a replacement for, or in mixture with actual rock dust.

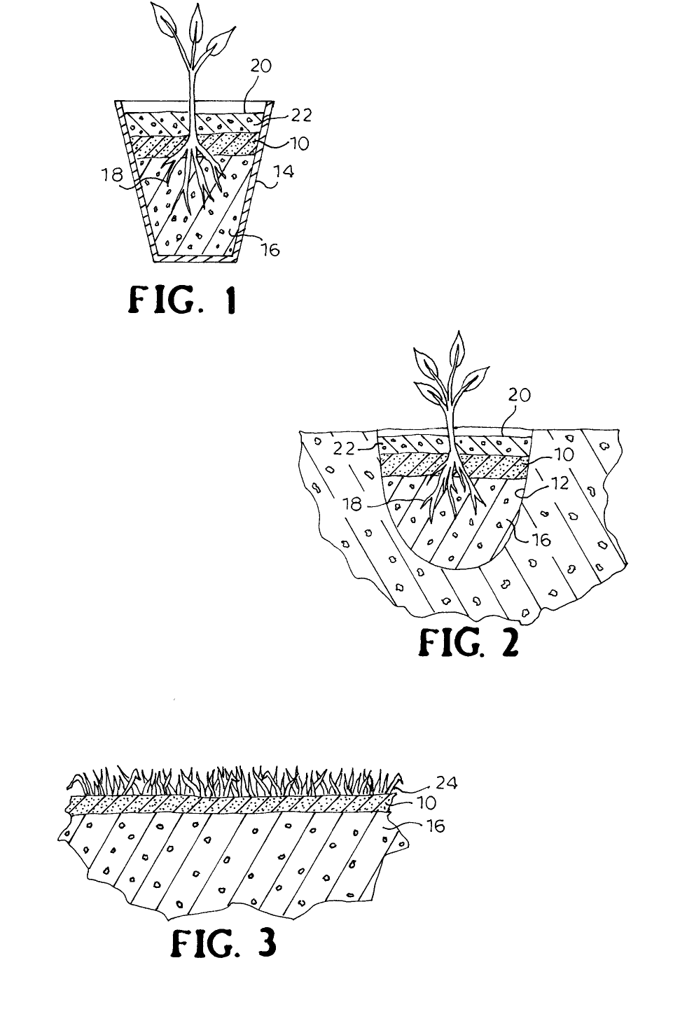

The method herein requires that a layer of rock dust 10 as discussed be located beneath the upper surface of the planted container, hole or area as shown in FIGS. 1-3, Preferably the layer of rock dust is no thinner than 1 inch thick and most preferably is at least 1 to 1 ¾ inch thick. Thicker layers of dust, for example, 2-3 inches of rock dust, are useful in certain circumstances, such as for planting large caliper trees.

The method of the invention herein includes determining which plant(s) are to be planted ardor to be treated with the method of the invention and the location where the plants are to be placed or are already located. If the plant is to be planted singly, for example, for planting, individual trees or other smaller plants at a growing location (FIG. 2), a hole 12 is dug at the location as known in the art or a pot 14 (FIG. 1) is selected for growing the plant. A lower layer 16 of suitable soil, such as potting soil or other plant growing medium as known in the art is used to fill in around the plant roots 18, preferably to within about just over an inch from the desired top 20 of the soil around the plant. Then a preferably even layer of rock dust 10 as specified herein is placed across the top of the lower layer 16, and finally a third layer of suitable soil as known in the art is placed over the rock dust 10 up to the desired top 20 of the soil around the plant. Although the depth of this third layer 22 is not critical to the invention herein, it is preferably shallow, preferably just being sufficiently thick enough (e.g.,¼- 1 inch thick) or as thick as is needed so that when the plant is watered the force of the water does not uncover the layer of rock dust 10. The plant is initially watered as usual, and then subsequently watered as needed. The examples herein show that such subsequent water using the method of the invention can typically be reduced by 33 to 60 per cent as compared to planting with prior art methods.

The same method as used for individual plants in the field is used for potted plants, preferably with the same three basic layers as discussed above (FIG. 1).

For large areas of planting, for example, areas to be covered with sod (golf course, city parks, football fields and the like), the areas can be prepared by adding the layer of rock dust over the soil present at the site or added thereto, which forms the third layer 22 in these large areas. Then the sod 24, which is the third layer, is placed over the layer of rock dust 10. For areas where sod is already present, the sod is preferably undercut so that a layer of rock dust can be inserted, for example by spreading or “injecting” the rock dust at the desired level and to the desired amount under the sod layer.

For areas to be newly seeded, such as a new lawn or an agricultural field, a layer of rock dust 10 is spread over the area that has been prepared for seeding as known in the art, and then a third layer 22 of preferably 1-3 inches of soil or other known planting material is placed over the rock dust 10.

While the three lavers (lower layer 16, rock dust 10 and third layer 22 (or sod 24) discussed above are preferred for planting, in some instances it may be practical and desirable to add additional dust layers separated by additional plant growing medium/soil layers, to increase the water retention.

The features of the present invention will be more clearly understood by reference to the following examples. are not to be construed as limiting the invention.

### Example 1

Circular holes are prepared outdoors in the ground in Midland, Tex., The holes have an upper diameter of about 30 inches. A layer of rock dust 1 inch thick is placed over soil placed in the hole and then a top layer of sod is placed over the rock dust so that there is sufficient space in the hole over the sod so that 30 gallons of water can be added to the hole. Control holes are the same but do not have the layer of rock dust. Thirty gallons of water are added to each hole. At the time at which all water has drained from the control holes and the control holes appear dry (which is always before the water has drained from the rock dust containing holes), the time is noted and the amount of water that has not yet drained from the rock dust containing holes is measured (“gallons remaining”). The holes continue to be observed and the time is noted when all water has drained from the rock dust containing holes and these holes also appear dry.

After 4-7 days, thirty gallons of water are again added to all holes and the measurements are repeated for each subsequent treatment

Typical results for three sequential treatments are shown in Table 1:

| | | | Gallons | |
|---|---|---|---|---|
| | Ambient | Drain time | remaining | Drain time |
| Treatment | Temperature | (control) | (rock dust) | (rock dust) |
| 1 | 90° F. | 3 hr, 6 min. | 10.5 | 7 hr, 30 min. |
| 2 | 89-95° F. | 2 hr, 5 min. | 7.5 | 7 hr, 35 min. |
| 3 | 95-100° F. | 2 hr | 11 | 8 hr, 30 min. |

In this example, the grass in the holes treated with rock, dust remains greener than in the control holes. Because the water is held longer in the rock dust containing holes, there is increased sideways seepage of water into soil surrounding the hole, so that more sod adjacent the bole is wetted. After a year without watering any of these holes, and only limited natural rainfall occurring, the holes with rock dust still hold water much longer than the control holes.

### Example 2

30-gallon containers are tilled to about 4 inches from the top with soil, followed by a 1-inch thick layer of rock dust. The containers have bottom drainage holes. Control pots have no rock dust and just soil. Because watering in this example is done with gentle sprinkling so as not to disturb the rock dust, no upper layer is needed. Twenty gallons of water are added to each pot and water that drains from the pot is collected. After 24 hours, the amount of water chaining from the ON is measured. The average drainage from control pots is 5 gallons (20 quarts) and the average drainage from rock dust containing pots is 2 quarts, which is a 10-fold increase in water retention capability of the pot treated according to the invention herein.

While the invention has been described with reference to specific embodiments, it will be appreciated that numerous variations, modifications, and embodiments are possible, and accordingly, all such variations, modifications, and embodiments are to be regarded as being within the spirit and scope of the invention.

1. A method of growing a plant that conserves water, comprising:
a) providing rock dust consisting of particles having an average diameter of no more than 74 microns;
b) providing a location for planting a plant;
c) providing a lower layer of plant growing medium;
d) placing a horizontal layer of rock dust over the lower layer of plant growing medium; and
e) placing an upper layer of plant growing medium over the horizontal layer of rock dust.

2. (canceled)

3. The method of claim 1, wherein the location comprises a plant-growing pot.

4. The method of claim 1, wherein the location is an outdoor location.

5. The method of claim 1, wherein the location is a sod field and the upper layer is a layer of sod.

6. The method of claim 1, wherein the horizontal layer of rock dust is 1 to 1 ¾ inch thick.

7. The method of claim 6, wherein the horizontal layer of rock dust is 1 inch thick.
